(19) United States
(12) Patent Application Publication
(10) Pub. No.: US 2014/0262385 A1
(43) Pub. Date: Sep. 18, 2014

(54) Coulter Disc Bolt Pattern

(71) Applicant: Kelley Manufacturing Company, Tifton, GA (US)

(72) Inventors: Mike Taunton, Sparks, GA (US); Bennie G. Branch, JR., Tifton, GA (US)

(73) Assignee: Kelley Manufacturing Company, Tifton, GA (US)

(21) Appl. No.: 14/068,100

(22) Filed: Oct. 31, 2013

Related U.S. Application Data
(60) Provisional application No. 61/800,929, filed on Mar. 15, 2013.

(51) Int. Cl. A01B 15/18; A01B 23/06

(52) U.S. Cl. CPC A01B 15/18; A01B 23/06
USPC 172/604

(57) ABSTRACT

A coulter disc for use in an agricultural implement is divided into a plurality of segments each having an arcuate pattern of bolt holes offset by a radius r from a displaced center such that material removed in dividing said coulter is accounted for when the disc is reassembled on an implement.

### FIELD OF INVENTION

The present invention relates to a bolt-hole pattern design for a coulter disc, a device commonly used in agricultural applications, that has an eccentric mounting pattern that allows the disc to be divided into individual sections and subsequently reassembled to create a concentric mounting pattern. In another embodiment, a bolt hole pattern design for a coulter disc, commonly used in agricultural applications, utilizes multiple spacing patterns allowing the disc to be divided into individual sections and reassembled in a way that the bolt holes are spaced closer to the divided edge of the disc segment than through the main body of the disc segment.

### BACKGROUND

Currently, coulter discs have a concentric mounting pattern and remain in a single or unitary disc form. This style of coulter disc has a center aperture and through which the mounting hub or axle on which the hub is secured must pass. Thus the disc must be slid over the mounting hub from one end or the other of the axle on which the coulter is carried in an implement assembly. A coulter is often mounted on the outer portion of the assembly when used as individual discs. Other applications using coulter discs, such as the ones in a disc harrow, have a common axle that runs through multiple discs. In such an arrangement, replacement of the innermost discs means that all of the discs between the disc to be replaced and the end of the axle roust be disengaged or removed from the axle to gain access to the inner discs. In some applications it would be beneficial to be able to remove and/or replace inner discs in an assembly without having to first disengage or remove the outer discs.

### SUMMARY OF THE INVENTION

It is an object of the present invention to facilitate the rapid replacement of coulter discs on agricultural implements. More particularly, it is an object of the invention to enable the replacement of coulter discs without the need to disengage or replace any other part of the implement. These and other objects of the invention are implemented through the use of a segmented disc which can be secured to the axle or hub in a manner that provides substantially the same stability and effectiveness as a standard solid disc. The specifics of such discs are set forth in the accompanying drawings and description.

### BRIEF DESCRIPTION OF THE DRAWINGS

Referring to the drawings which are appended hereto and which form a portion of this disclosure, it may be seen that:

FIG. 1 is side elevation view of a coulter showing the eccentric offset of the pattern;

FIG. 2 is a side elevation view of the bolt pattern on two coulter portions; and,

FIG. 3 is a perspective view of this embodiment of the coulters mounted on an axle.

FIG. 4 is a perspective view of a second aspect of the invention showing a capture device joining edges of the segments.

FIG. 5 is a perspective view of an assembly using multiple coulters and mounting flanges.

FIG. 6a & b is a side elevation view of two variations of a securing Device.

### DETAILED DESCRIPTION

One or more of the above objects can be achieved, at least in part, by providing a bolt-hole design in the coulter discs such that the mounting pattern of a manufactured disc compensates for material loss during division of the disc by utilizing an eccentric mounting pattern as shown in the embodiment illustrated in FIG. 1. Note that FIG. 1 is a unitary coulter disc 11, with a unique mounting pattern on both sides A and B. The patterns are comprised of a set of holes 12 that are radially spaced by a specified angle θ, and are set a distance R, from the theoretical center of each set of holes. This theoretical center is offset from the centerline of the disc by a distance X. It is to be understood that the distance X is proportional to the amount of material removed from the disc when the disc is divided into segments. That Is to say, if the disc 11 is mechanically divided into segments such as by a saw or laser cutting tool, then a volume of the disc along the centerline is removed by the saw. This volume will have a width dimension along the centerline such that if the disc is formed with bolt holes 12 spaced radially concentric with the geometric center of the disc, then divided into segments and rejoined by bolting onto a flange 14 welded to a support 16, such as an axle, a gap will be left between the leading and trailing edges of the segments. By offsetting the center of the arc formed by the holes 12 in each segment 21, 31 from the geometric center, then, when the disc is divided along the centerline, CL, the resulting coulter segments 21 and 31 can be rejoined in a manner so that the theoretical centers are aligned and form a concentric mounting pattern with minimal clearance along the divided edge. The resulting concentric pattern makes an otherwise arduous task of mounting coulter discs in the center of an assembly require less time and energy consumptive. Repair of inner discs in one such assembly shown in FIG. 3 would not be possible without this method of dividing coulter discs because the flanges shown at 14, are welded in place and would have to be cut loose and re-welded each time an inner coulter disc requires replacing.

The bolt-hole patterns currently available in coulter discs use a single pattern to space the bolt holes radially around the disc. Should the common disc be divided and reassembled it will leave an unsupported area between the divided edge of the disc and the center of the nearest bolt hole. This unsupported area allows the disc edges to twist and deform while engaging the ground in the manner in which it was designed. By employing the method of multiple patterns, the spacing between the holes 12 through the body of the segmented disc can have one value and the distance between the edge of disc and the nearest hole can have a different value that may or may not be a multiple of the first value. Shown in FIG. 1, the spacing between the bolt holes 12 is θ and the angle between the divided edge of the coulter and the nearest hole 12 is α. It is evident from this figure that the divided edge of the coulter will be much closer to the first bolt hole because of the multiple pattern spacing, which will in turn provide more support to the coulter edges than if the constant spacing θ was maintained.

It may be noted that the forces applied to the segments at the leading edges 21a, 31a and trailing edges 21b, 31b thereof when the coulter disc is in use may tend to displace the edges from each other transversely of the plane of the disc. This is even more pronounced when the edges of the segments are not in close contact with each other. To combat displacement of the edges, we have devised capture elements 15 that will hold the edges of adjacent segments in close relation to each other. As shown in FIGS. 4 and 6, capture elements 15 are received in apertures 22 formed in the coulter disc at a distance Y along the dividing centerline such that the dividing centerline passes through the center of the aperture such that a crescent or semi-circular section of adjacent segments is removed along its leading and trailing edges. When the disc is reassembled using the bolt holes 12 and complimentary bolts to attach the segments to a flange 14, a complete aperture 22 is reformed to receive the capture element. As shown in FIG. 6a & b the capture elements 15 may be a bolt 24 and nut 25 with washers 26 secured within the aperture when the disc segments are rejoined. Likewise a specialized spool shaped capture element 15′ having a beveled periphery 33 may also be positioned in the two part aperture 22 when segments 21, 31 are secured to flange 14. In either form of the capture element a connecting member passes through the aperture 22 and carries to two distended bearing surfaces perpendicular to the axis of the connecting member, with the bearing surfaces substantially abutting opposite sides of the coulter disc. The capture device thus 15 holds the adjacent edges of the segment together during the utilization of the coulter disc.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What we claim is:

1. A coulter disc for use in an agricultural assembly, comprising:
a. A disc divided into a plurality of segments, said disc having a central aperture and a substantially concentric outer periphery, each segment having a substantially linear radially extending leading and trailing edge;
b. A plurality of bolt holes defined in each of said plurality of segments proximal said central aperture, with said plurality of bolt holes including a leading and trailing bolt hole proximal said leading and trailing edge of said segment such that the leading and trailing edges of adjacent segments are secured by bolts passing through said leading and trailing bolt holes and a complementary element of said rotating assembly.

2. A coulter disc as defined in claim 1 wherein said bolt holes are eccentrically defined in said disc with each bolt hole in each segment separated by an angle θ from each adjacent bolt hole in said segment and spaced a radial distance R from a theoretical center of an arc formed by said bolt holes, said theoretical center being offset from a geometric center of said segment.

3. A coulter disc as defined in claim 2 wherein said theoretical center is offset from said geometric center by a distance proportional to the material removed in dividing said disc into said segments.

4. A coulter disc divided into a plurality of segments and having a central aperture formed therein for receiving a support member there through said coulter disc having a plurality of bolt holes formed in spaced relation to said center aperture, said bolt holes in each segment each spaced a distance R from a common point offset by a distance x perpendicular to a line passing through the geometric center of said disc and dividing said disc into said segments.

5. A coulter disc as defined in claim 4 wherein said distance x is a distance proportional to the material removed in dividing said disc into said segments.

6. A coulter disc as defined in claim 4 wherein:
a. each segment has a substantially linear radially extending leading and trailing edge; and,
b. Said plurality of bolt holes, defined in each of said plurality of segments, including a leading and trailing bolt hole proximal said leading and trailing edge of said segment such that the leading and trailing edges of adjacent segments are secured by bolts passing through said leading and trailing bolt holes and a complementary element of said rotating assembly.

7. A coulter disc as defined in claim 4 wherein said plurality of bolt holes defined in each of said plurality of segments includes a leading and trailing bolt hole proximal said line passing through the geometric center of said disc and dividing said disc into said segments such that edges of adjacent segments are secured by bolts passing through said leading and trailing bolt holes and a complementary element of said rotating assembly.

8. A coulter disc as defined in claim 4 wherein each bolt hole in each segment is separated by an angle θ from each adjacent bolt hole in that segment.
